(19) United States
(12) Patent Application Publication
(10) Pub. No.: US 2014/0267267 A1
(43) Pub. Date: Sep. 18, 2014

(54) STITCHING OF VOLUME DATA SETS

(71) Applicants: KABUSHIKI KAISHA TOSHIBA, Tokyo (JP); TOSHIBA MEDICAL SYSTEMS CORPORATION, Otawara-shi (JP)

(72) Inventor: Jim PIPER, Edinburgh (GB)

(73) Assignees: Toshiba Medical Systems Corporation, Otawara-shi (JP); KABUSHIKI KAISHA TOSHIBA, Tokyo (JP)

(21) Appl. No.: 13/838,029

(22) Filed: Mar. 15, 2013

(51) Int. Cl. G06T 15/08; G09G 5/377

(52) U.S. Cl. CPC G06T 15/08; G09G 5/377
USPC 345/424

(57) ABSTRACT

Certain embodiments provide a computer apparatus operable to carry out a data processing method to stitch together overlapping three-dimensional image data sets to form a joint data set. The data processing comprises: a) providing first and second volumes which overlap; b) performing a non-rigid registration of the first volume with respect to the second volume to define an overlap domain in which a warp field maps voxel locations in the first volume to voxel locations in the second volume; and c) constructing a joint data set in which voxel values of voxels at voxel locations outside the overlap domain are taken from the first and second volumes respectively and voxel values for voxels inside the overlap domain are generated for each particular voxel location by combining: (i) a first voxel value taken from the first volume at a first point shifted from said voxel location by a first warp field, and (ii) a second voxel value taken from the second volume at a second point shifted from said voxel location by a second warp field.

### BACKGROUND OF THE INVENTION

Embodiments described herein generally relate to three-dimensional (3D) image data sets and in particular how to stitch together overlapping 3D image data sets into a single joint data set.

In the medical field, three-dimensional (3D) image data sets, i.e. volume data sets, are collected by a variety of techniques—referred to as modalities in the field—including computer assisted tomography (CT), magnetic resonance (MR), single photon emission computed tomography (SPECT), ultrasound and positron emission tomography (PET).

It is quite common that a study includes two or more captured data sets which partially or completely overlap. Two overlapping 3D data sets may be acquired by two CT scans of adjacent regions. The same occurs with MR scans.

When a CT or MR study is captured as a set of two or more overlapping scans, it is desired to merge the multiple overlapping volumes from these scans to create a single 3D image data set which can then be processed by a visualization application, for example rendered into 2D images.

Merging multiple overlapping 3D image data sets can be referred to as “stitching”. A naïve stitching is based simply on combining the voxels based on patient coordinate information. However, this approach will usually result in visible artifacts at the join, including intensity and geometrical discontinuities. Discontinuities will tend to result either in duplication or loss of anatomical features in the stitched data set.

Stitching of 2D images is of course well known in digital photography—for example when making a panorama. In the medical imaging field, stitching of 2D images is also well known, for example stitching for computed radiography 2D images. From a brief literature search it appears that methods for stitching 3D image data sets are less well known.

One known method for stitching 3D medical image data sets is described in US 2010/0067762 by Glocker, Navab, Wachinger and Zeltner. The method of US 2010/0067762 stitches MR image data sets using a weighted superposition of the first and second image data sets in the overlap region such that the weighting given to voxels of each image data set gradually decreases towards the edge of that image data set. An iterative approach of repeated transforms is used to improve the smoothness of the transition at the overlap.

Generally what is desired for stitching 3D image data sets is an automated computational method that will provide a smooth transition from one volume to the next in both intensity and geometry. The stitching method should avoid loss or duplication of volume data. The method should also be insensitive to the order in which the stitching is performed, i.e. whether a first data set is merged into a second data set or vice versa. Moreover, the stitching method should be able to compensate for small amounts of patient motion that may have occurred between acquisition of the first and second data sets of the kind that causes misalignments and warping distortion between the two image data sets. One example cause of misalignments and warping distortion are motions associated with breathing of the patient. Another example is scanner-dependent geometrical and/or intensity inhomogeneities, which can be a particular problem in MR.

### BRIEF DESCRIPTION OF THE DRAWINGS

Embodiments of the invention are now described by way of example only with reference to the following drawings.

FIG. 1A schematically illustrates first and second data sets I₁ and I₂ which it is desired to stitch together to form a single joint data set.

FIG. 1B schematically illustrates the first and second data sets after pre-alignment of the second data set I₂→I′₂ so that its voxels are in the same coordinate system as the voxels of the first data set I₁.

FIG. 2 illustrates an overlap domain D defined by a warp field mapping between locations in the first and second data sets.

FIGS. 3, 4 and 5 schematically illustrate subsequent steps of a stitching method in which first and second warp fields w₁ and w₂ are defined over D and used to generate data values y in the joint data set.

FIG. 6 illustrates schematically stitching of first and second data sets (a) having convex and concave distortions, with the stitching being performed: according to a naïve method (b) and (c); and the method described herein (d).

FIG. 7 is a flow diagram summarizing the stitching method.

FIG. 8 is a schematic diagram showing an exemplary network of diagnostic devices and associated equipment.

FIG. 9 shows a generic CT scanner for generating volume data.

FIG. 10A and FIG. 10B schematically show a computer system for processing image data in accordance with an embodiment of the invention.

FIG. 11 schematically shows some of the features of the computer system of FIG. 10A and FIG. 10B in more detail.

### DETAILED DESCRIPTION

Certain embodiments of the invention provide an apparatus for and method of stitching together overlapping three-dimensional image data sets to form a joint data set,

In accordance with some embodiments a computer apparatus operable to carry out a data processing method to stitch together overlapping three-dimensional image data sets to form a joint data set is provided. The data processing may comprise: a) providing first and second volumes which overlap; b) performing a non-rigid registration of the first volume with respect to the second volume to define an overlap domain in which a warp field maps voxel locations in the first volume to voxel locations in the second volume; and c) constructing a joint data set in which voxel values of voxels at voxel locations outside the overlap domain are taken from the first and second volumes respectively and voxel values for voxels inside the overlap domain are generated for each particular voxel location by combining: (i) a first voxel value taken from the first volume at a first point shifted from said voxel location by a first warp field, and (ii) a second voxel value taken from the second volume at a second point shifted from said voxel location by a second warp field.

The first and second warp fields may vary between an identity warp and a full warp depending on to what degree a voxel location in the overlap domain belongs to the first volume and the second volume.

To what degree a voxel location in the overlap domain belongs to the first volume and the second volume may be defined by a distance function having as parameters a first distance from the voxel location to the nearest point in the first volume which is not inside the second volume and a second distance from the voxel location to the nearest point in the second volume which is not inside the first volume.

The combining may be a weighted combination based on the distance function.

Some embodiments may further comprise a pre-processing step before performing the non-rigid registration, wherein the voxels of at least one of the first and second volumes are transformed so that the first and second volumes have a common coordinate system.

In accordance with some embodiments a computer-automated data processing method for stitching together overlapping three-dimensional image data sets to form a joint data set is provided. The data processing method may comprise: a) providing first and second volumes which overlap; b) performing a non-rigid registration of the first volume with respect to the second volume to define an overlap domain in which a warp field maps voxel locations in the first volume to voxel locations in the second volume; and c) constructing a joint data set in which voxel values of voxels at voxel locations outside the overlap domain are taken from the first and second volumes respectively and voxel values for voxels inside the overlap domain are generated for each particular voxel location by combining: (i) a first voxel value taken from the first volume at a first point shifted from said voxel location by a first warp field, and (ii) a second voxel value taken from the second volume at a second point shifted from said voxel location by a second warp field.

In accordance with some embodiments a non-transitory computer program product storing machine readable instructions for performing a computer-automated data processing method in accordance with embodiments of the invention is provided.

In accordance with some embodiments an image acquisition device loaded with and operable to execute machine readable instructions for performing a computer-automated data processing in accordance with embodiments of the invention is provided.

In the figures, the method is illustrated for 2D images, since it would not be easily possible to present figures that show 3D images in an intelligible way. However, the 2D images illustrate the principles applied to the method of stitching 3D images.

FIG. 1A shows a first 2D data set I₁ represented by a vertically arranged rectangle containing a square mesh, wherein the blocks in the square mesh represent pixels (voxels in a 3D data set) as well as an overlapping second 2D data set I₂ represented by an obliquely arranged rectangle, wherein the axes in the square mesh of the second data set are not aligned with those of the first data set. This mis-alignment represents the general case in which the respective coordinate systems of the first and second data sets do not coincide.

It will be understood that the illustrated 2D data sets I₁ band I₂ correspond to 3D data sets of first and second volumes in an embodiment of the invention. Moreover, the blocks in the square mesh representing pixels in 2D correspond to voxels in 3D.

FIG. 1B illustrates the outcome of a pre-alignment step in which the pixels (voxels) of the second area (volume) are transformed with a transform I₂→I′₂ so that they have a common coordinate system with the pixels (voxels) of the first area (volume), i.e. I′₂ shares the coordinate system of I₁. The image data sets can be pre-aligned in a variety of ways. Most simply, they can be aligned by using the coordinates provided by the respective scanners used to obtain the two data sets. A more sophisticated approach would be to align the two data sets by a rigid registration. It is also noted that in some cases no pre-alignment will be needed, i.e. when the two data sets were acquired with the same coordinate systems.

In this worked example, we also assume that the coordinate system of I₁ is used as the final coordinate system of the stitched images. Generally the final coordinate system could be any coordinate system, but it will in most cases be easiest and most convenient to choose either I₁ or I₂ for the final coordinate system.

FIG. 2 schematically illustrates the next step of the method which is to perform a non-rigid registration of the first volume with respect to the second volume. A warp field maps voxel locations in the first volume to voxel locations in the second volume, with this linkage defining an overlap domain D. Namely, performing non-rigid registration of I′₂ with respect to I₁ results in a warp field w:I₂→R² valid for the overlap domain D so that if x is a point in I₁ then x+w(x) is a corresponding point in I′₂. The overlap domain D is thus the subset of I₁ that w maps onto I′₂. Note that as illustrated in the schematic example of FIG. 2, the overlap domain D does not necessarily cover all of I₁∩I′₂. Let 0≦b(x)≦1:R²→R be a “blending” or “distance” function for D that indicates the degree to which a point xεD belongs to I′₂ rather than to I₁. For example,

b(x)=d₁(x)/(d₁(x)+d₂(x))

where d₁(x) is the distance from x to the nearest point of I₁\I′₂—which we call the first distance—and d₂(x) is the distance from x to the nearest point of I′₂\I₁—which we call the second distance. [In this notation “\” means “excluding” or “not inside” so for example I₁\I′₂ denotes that part of I₁ which is not overlapping with I′₂.] The first distance d₁(x) from the voxel location to the nearest point in the first volume which is not inside the second volume and the second distance d₂(x) is the distance from the voxel location to the nearest point in the second volume which is not inside the first volume.

FIG. 3 schematically illustrates the next step of the method which is to construct first and second warp fields w₁ and w₂ defined over D as follows. For each integer coordinate xεD, let y=round(x+b(x)w(x)) where round(.) is a function that returns the nearest integer-valued coordinate to a real-valued coordinate. The rounding function is needed to force the result of each application of the warp onto a coordinate lying in the grid of the final coordinate system, since the voxels in the joint data set need to be arranged in a common grid or mesh.

FIG. 4 schematically illustrates how the first and second warp fields for the overlap domain are defined. Namely, if and only if yεD:

w₁(y)=−b(x)w(x)

w₂(y)=(1−b(x))w(x)

Since the mapping from x to y is not necessarily one-to-one, some y in D will result from more than one x in D. On the other hand, some y in D may not be “hit” at all by w, i.e. there may be some voxel locations in the final coordinate system that are not assigned values at all from the warp. The first issue where there are multiple hits per voxel can be handled either by averaging, or more simply by taking the last value assigned to that point during the warp. The second issue where there are zero hits on a particular voxel can be handled by propagating valid values into undefined elements of w₁ and w₂, for example by interpolation from neighboring values or simply assigning a value from the nearest neighbor.

FIG. 5 illustrates the final step in the method which is to generate the joint data set J for the union of I₁ and I′₂. The voxel values of voxels at voxel locations outside the overlap domain are trivially obtained from the first and second volumes as appropriate. For voxels inside the overlap domain, voxel values are generated for each particular voxel location by combining (i) a first voxel value taken from the first volume at a first point shifted from said voxel location by a first warp field, and (ii) a second voxel value taken from the second volume at a second point shifted from said voxel location by a second warp field. Namely the joint data set is calculated according to the following expression:

If (xεI₁\D) then J(x)=I₁(x).

Else if (xεI′₂\I₁) then J(x)=I′₂(x).

Else J(x)=(1−b(x))I₁(x+w₁(x))+b(x)I′₂(x+w₂(x))

The combination in the overlap domain is thus a weighted combination based on the distance function b(x) as well as the two warp fields w₁ and w₂. It is noted this expression accounts for the possibility that I₁\D and I′₂\D are not disjoint, as schematically illustrated in FIG. 2.

The above logic expresses that if xεD then the method forms a weighted sum using blending function b(x). It is noted that I′₂(x+w₂(x)) can in practice be directly interpolated from I₂, by combining w₂ with the pre-alignment transformation from to I₂ to I′₂ shown schematically in FIG. 1B.

The method described is significantly better than a naïve method of stitching based simply on a registration followed by intensity blending of the voxel values. The problem with registration followed by intensity blending is that the result would depend strongly on which of the two coordinate systems is chosen for the final coordinate system, i.e. there is a strong asymmetry between I₁ and I₂. Whichever of I₁ and I₂ were chosen as the reference for the registration would dictate the distortion in the overlap region. As well as the asymmetry problem, the lack of a gradual evolution of the warp over the overlap region would lead to a harsh and obvious transition at one of the overlap boundaries.

The definition of two warp fields which slide inversely between the identity warp and the full warp, depending on the distance function b(x), provides a gradual transition in the overlap domain which ensures that in the joint data set J(x) close to I₁, the warp of I₁ dominates, and close to I₂ the warp of I₂ dominates, with a smooth transition in between. The intensities, i.e. voxel values, are also gradually varied based on the distance function. Thus no harsh boundary should be seen anywhere.

In the proposed method, the choice of I₁ and I₂ is not entirely arbitrary, as one would ideally like, since registering I₁→I₂ cannot guarantee to produce the perfect inverse of registering I₂→I₁). Nevertheless, any asymmetry associated with this choice should be marginal because of the way in which both the coordinates and the voxel values are smoothly transitioned over the region of overlap.

FIG. 6 schematically illustrates a particular example in which I₁ is distorted (for some reason) in a convex shape while I₂ distorted in a concave way—see data sets I₁ and I₂ schematically illustrated at (a). The naïve method would create a convex or concave transition depending on the assignment of I₁ and I₂ with (b) showing the option where I₁ was chosen as the final coordinate system and (c) showing the option where I₂ was chosen as the final coordinate system. With the proposed method, the outcome is as schematically illustrated at (d), namely that there is a smooth and gradual transition which is substantially unaffected by the choice of which data set to base the pre-alignment upon.

FIG. 7 is a flow diagram summarizing the stitching method described above.

In Step 1, first and second volumes which overlap are loaded from memory, for example from a DICOM file store or a file store local to a particular scanning instrument or personal computer or workstation.

In Step S2, a pre-alignment is carried out which transforms the voxels of at least one of the first and second volumes so that the voxels of the first and second volumes lie in a common mesh or grid. Typically the voxels of one of the volumes are transformed to conform to the existing mesh or grid of the other volume.

In Step S3, a non-rigid registration of the first volume is carried out with respect to the second volume to define an overlap domain D in which a warp field w maps voxel locations in the first volume to voxel locations in the second volume.

In Step S4, a joint data set is computed. Voxel values of voxels at voxel locations outside the overlap domain are taken from the first and second volumes respectively. Voxel values for voxels inside the overlap domain are generated for each particular voxel location by a weighted combination of: a first voxel value taken from the first volume at a first point shifted from said voxel location by a first warp field; and a second voxel value taken from the second volume at a second point shifted from said voxel location by a second warp field. Moreover, the first and second warp fields vary gradually between an identity warp and a full warp depending on a blending function sensitive to the relative proximity of the voxel location to adjacent non-overlapping parts of the first and second volumes.

In Step S5, the resultant joint data set is output. The output could be simply for storage or to be output to a rendering module for visualization.

Although the method has been described in terms of stitching two volumes, it can be extended to stitching three or more volumes.

Moreover, although the method has been described with an example in which the two volumes only overlap in a relatively small region, the method is applicable to any degree of overlap, including the situation in which one data set is fully contained in the other or both data sets have substantially or exactly the same extent.

The method as described above will be implemented in software or in a combination of software and optimized or dedicated hardware, such as graphics cards or chip sets suitable for or optimized to handling of volume data sets and subsequent rendering. The software for stitching volume data sets will in practice most likely be a module that forms part of a rendering application which may run on a computer workstation or a server which is part of a network operating under a client-server model. The usual context for the workstation or server on which the rendering application is resident will be a hospital network as now described. If desired, the stitching module could be applied to volume data sets and the resultant joint data set could be stored in memory without carrying out visualization in the same session.

FIG. 8 is a schematic representation of an exemplary network 1 of computer controlled diagnostic devices, stand-alone computer workstations and associated equipment. The network 1 comprises three components. There is a main hospital component 2, a remote diagnostic device component 4 and a remote single user component 6. The main hospital component 2 comprises a plurality of diagnostic devices for acquiring patient images, in this example, a CT scanner 8, a MR imager 10, a digital radiography (DR) device 12 and a computed radiography (CR) device 14, a plurality of computer workstations 16, a common format file server 18, a file archive 20 and an internet gateway 15. All of these features are inter-connected by a local area network (LAN) 25. It will be understood that each computer apparatus has at least one network output connection for communicating over the network.

The remote diagnostic device component 4 comprises a CT scanner 11, a common format file server 13 and an internet gateway 17. The CT scanner 11 and file server 13 are commonly connected to the internet gateway 17, which in turn is connected via the internet to the internet gateway 15 within the main hospital component 2.

The remote single user component 6 comprises a computer workstation 21 with an internal modem (not shown). The computer workstation 21 is also connected via the internet to the Internet gateway 15 within the main hospital component 2.

The network 1 is configured to transmit data within a standardized common format. For example, the CT scanner 8 initially generates a source data set, i.e. a 3D image data set, from which an operator may derive an appropriate 2D image. The 2D image is encoded in a standard image data format and transferred over the LAN 25 to the file server 18 for storage on the file archive 20. A user working on one of the computer workstations 16 may subsequently request the image, the file server 18 will retrieve it from the archive 20 and pass it to the user via the LAN 25. Similarly, a user working remotely from the main hospital component 2, either within the remote diagnostic device component 4, or the remote single user component 6, may also access and transmit data stored on the archive 20, or elsewhere on the network 1.

FIG. 9 is a schematic perspective view of a generic scanner, most especially a computer-assisted tomography (CT) scanner 8 such as represented in FIG. 8, for obtaining cross-sectional images on X-ray attenuation associated with a region of a patient 5 within an opening 7 of the scanner 8. Different imaging modalities (e.g. CT, MR, PET, ultrasound) may be used to provide different types of medical image data.

With reference to FIG. 8 and FIG. 9, a rendering application with a stitching module embodying the invention may be resident on any of the computer apparatuses shown, namely the workstations 6, 16, the servers 13, 15, 17, 18 or the computers and any associated graphics processing hardware associated with the scanners 8, 10, 11, 12, 14.

FIGS. 10A and 10B schematically illustrate a general purpose computer system 22 configured to perform processing in accordance with an embodiment of the invention. FIG. 10A primarily represents the functional units comprising the computer system 22 while FIG. 10B is a schematic perspective view showing the computer system 22 arranged for use.

The computer 22 includes a central processing unit (CPU) 24, a read only memory (ROM) 26, a random access memory (RAM) 28, a hard disk drive 30, a display driver 32, and two displays 34, namely a first display 34A and a second display 34B, and a user input/output (IO) circuit 36 coupled to a keyboard 38 and mouse 40. These devices are connected via a common bus 42. The computer 22 also includes a graphics card 44 connected via the common bus 42. The graphics card includes a graphics processing unit (GPU) and random access memory tightly coupled to the GPU (GPU memory).

The CPU 24 may execute program instructions stored within the ROM 26, the RAM 28 or the hard disk drive 30 to carry out processing, display and manipulation of medical image data that may be stored within the RAM 28 or the hard disk drive 30. The RAM 28 and hard disk drive 30 are collectively referred to as the system memory. The CPU 24 may also execute program instructions corresponding to an operating system of the computer system 22. In this respect, the CPU may be considered to comprise various functional units for performing tasks associated with the operation of the computer system 22. The GPU may also execute program instructions to carry out processing image data passed to it from the CPU.

Various functional elements comprising the computer system 22, such as the CPU 24, ROM 26, RAM 28, hard disk 30, display driver 32, user input/output (IO) circuit 36, graphics card 44 and connection bus 42 are contained in an enclosure 21. The two displays 34A, 34B, keyboard 38 and mouse 40 are in this case separate from the enclosure with appropriate wiring connecting them back to the relevant functional elements of the computer system in the enclosure 21. In this respect the computer system 22 of the example embodiment in FIGS. 10A and 10B may be considered as being of a desktop type, although other types of computer system could equally be employed.

FIG. 11 schematically shows some of the features of the computer system 2 shown in FIG. 10A and FIG. 10B in more detail. The RAM 28 and hard disk drive 30 are shown collectively as a system memory 46. Medical image data obtained from the scanner 8 shown in FIG. 8 is stored in the system memory as shown schematically in the figure. To assist in showing the different data transfer routes between features of the computer system 22, the common bus 42 shown in FIG. 10A is schematically shown in FIG. 10 as a series of separate bus connections 42a-d. One bus connection 42a connects between the system memory 46 and the CPU 24. Another bus connection 42b connects between the CPU 24 and the graphics card 44. A further pair of bus connections, namely a first bus connection 42cA and a second bus connection 42cB, connects between the graphics card 44 and respective ones of the displays 34A, 34B. Another bus connection 42d connects between the user I/O circuit 36, cursor control unit 27 and the CPU 24. The CPU includes a CPU cache 50. The graphics card 44 includes a GPU 54 and a GPU memory 56. The GPU 54 includes circuitry for providing an accelerated graphics processing interface 60, a GPU cache I/O controller 62, a processing engine 64 and a display I/O controller 66. The processing engine 64 is designed for optimized execution of the types of program instructions typically associated with processing medical image data sets.

A user is able to select desired processing parameters using the keyboard 38 and mouse 40 (or other pointing device, such as a track pad or pen tablet/digitizer) in combination with a graphical user interface (GUI) displayed on the display 34, for example using a movable screen cursor in combination with the mouse, track pad etc. to point and click within respective ones of the first and second displays 34A, 34B.

With reference to FIG. 10A, FIG. 10B and FIG. 11, the rendering application with stitching module embodying the invention may be stored on HDD 30 and/or ROM 26. When the application is to be run, it can as necessary be loaded into system memory 46 or RAM 28. At run time, faster memory such as cache memory 50, 62 available to the CPU 24 and GPU 54, will also host some of the application. The images output from the rendering application can be displayed on suitable displays, such as first and second displays 34A, 34B. The images output from the rendering application can also be stored in suitable memory. The images output from the rendering application can also be transmitted over the network to be displayed or stored at another location in the network.

Moreover, references to three-dimensional image data sets includes sequences of three dimensional image data sets, such as produced by time-resolved imaging which are sometimes referred to as four-dimensional image data sets.

Certain embodiments of the invention provide a computer program product, which may be a non-transitory computer program product, bearing machine readable instructions for carrying out the method.

Certain embodiments of the invention provide a computer system loaded with and operable to execute machine readable instructions for carrying out the method.

Certain embodiments of the invention provide an image acquisition device loaded with and operable to execute machine readable instructions for carrying out the method.

Embodiments of the present invention will be described hereinafter and in the context of a computer-implemented system, method and computer program product which may be stored on a non-transitory medium. Although some of the present embodiments are described in terms of a computer program product that causes a computer, for example a personal computer or other form of workstation, to provide the functionality required of some embodiments of the invention, it will be appreciated from the following description that this relates to only one example of some embodiments of the present invention. For example, in some embodiments of the invention, a network of computers, rather than a stand-alone computer, may implement the embodiments of the invention. Alternatively, or in addition, at least some of the functionality of the invention may be implemented by means of special purpose hardware, for example in the form of special purpose integrated circuits (e.g., Application Specific Integrated Circuits (ASICs)).

While certain embodiments have been described, these embodiments have been presented by way of example only, and are not intended to limit the scope of the inventions. Indeed, the novel methods, computers and computer program products and devices described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer apparatus operable to carry out a data processing method to stitch together overlapping three-dimensional image data sets to form a joint data set, the data processing method comprising:
a) providing first and second volumes which overlap;
b) performing a non-rigid registration of the first volume with respect to the second volume to define an overlap domain in which a warp field maps voxel locations in the first volume to voxel locations in the second volume; and
c) constructing a joint data set in which voxel values of voxels at voxel locations outside the overlap domain are taken from the first and second volumes respectively and voxel values for voxels inside the overlap domain are generated for each particular voxel location by combining:
(i) a first voxel value taken from the first volume at a first point shifted from said voxel location by a first warp field, and
(ii) a second voxel value taken from the second volume at a second point shifted from said voxel location by a second warp field.

2. The apparatus of claim 1, wherein the first and second warp fields vary between an identity warp and a full warp depending on to what degree a voxel location in the overlap domain belongs to the first volume and the second volume.

3. The apparatus of claim 2, wherein to what degree a voxel location in the overlap domain belongs to the first volume and the second volume is defined by a distance function having as parameters a first distance from the voxel location to the nearest point in the first volume which is not inside the second volume and a second distance from the voxel location to the nearest point in the second volume which is not inside the first volume.

4. The apparatus of claim 3, wherein said combining is a weighted combination based on the distance function.

5. The apparatus of claim 1, further comprising a pre-processing step before performing the non-rigid registration, wherein the voxels of at least one of the first and second volumes are transformed so that the first and second volumes have a common coordinate system.

6. A computer-automated data processing method for stitching together overlapping three-dimensional image data sets to form a joint data set, the data processing method comprising:
a) providing first and second volumes which overlap;
b) performing a non-rigid registration of the first volume with respect to the second volume to define an overlap domain in which a warp field maps voxel locations in the first volume to voxel locations in the second volume; and
c) constructing a joint data set in which voxel values of voxels at voxel locations outside the overlap domain are taken from the first and second volumes respectively and voxel values for voxels inside the overlap domain are generated for each particular voxel location by combining:
(i) a first voxel value taken from the first volume at a first point shifted from said voxel location by a first warp field, and
(ii) a second voxel value taken from the second volume at a second point shifted from said voxel location by a second warp field.

7. The method of claim 6, wherein the first and second warp fields vary between an identity warp and a full warp depending on to what degree a voxel location in the overlap domain belongs to the first volume and the second volume.

8. The method of claim 7, wherein to what degree a voxel location in the overlap domain belongs to the first volume and the second volume is defined by a distance function having as parameters a first distance from the voxel location to the nearest point in the first volume which is not inside the second volume and a second distance from the voxel location to the nearest point in the second volume which is not inside the first volume.

9. The method of claim 8, wherein said combining is a weighted combination based on the distance function.

10. The method of claim 6, further comprising a pre-processing step before performing the non-rigid registration, wherein the voxels of at least one of the first and second volumes are transformed so that the first and second volumes have a common coordinate system.

11. A non-transitory computer program product storing machine readable instructions for performing the computer-automated data processing method of claim 6.

12. An image acquisition device loaded with and operable to execute machine readable instructions for performing the computer-automated data processing method of claim 6.
